(19) United States
(12) Patent Application Publication
(10) Pub. No.: US 2012/0036494 A1
(43) Pub. Date: Feb. 9, 2012

(54) WEB-BASED CROSS-PLATFORM WIRELESS DEVICE APPLICATION CREATION AND MANAGEMENT SYSTEMS, AND METHODS THEREFOR

(75) Inventors: PRABHANJAN C. GURUMOHAN, Los Altos, CA (US); Rahul Patel, Los Altos, CA (US)

(73) Assignee: GENWI, INC., Los Altos, CA (US)

(21) Appl. No.: 13/204,478

(22) Filed: Aug. 5, 2011

Related U.S. Application Data
(60) Provisional application No. 61/371,588, filed on Aug. 6, 2010.

(51) Int. Cl. G06F 9/44; G06F 15/16

(52) U.S. Cl. 717/106; 717/173; 709/219; 709/246; 709/203

(57) ABSTRACT

The smart phone and tablet applications are akin to news and media websites available on the Internet in that the applications provide the latest content, richest media experience and an evolving community around the brand. The disclosure provides an efficient and inexpensive process and system for creating and managing of software applications for multiple smart phone and tablet platforms via an online platform. The systems and processes facilitate creation of applications, which communicate with a workflow implemented and powered by an online server. The systems also provides a feed server system that continuously fetches content from various feed sources, aggregates content, and maps into a local data model that can be defined dynamically. The applications are containers that request content from the served based on a token that is preinstalled into the application. The containers are built with the mechanism to bind data to layouts dynamically using the scripting code downloaded from an online server. The data, layouts and code can all be changed by the app creator on the fly. Based on the specifications of the device making the request, the token content is preprocessed and served to the application in the correct format for the receiving device. The apps combined with the online app server also provide mechanism to gather analytics about content consumptions habits, location analytics, and application usage patterns all of which could be used to curate content to be served back to the app users.

### CROSS-REFERENCE

This application claims the benefit of U.S. Provisional Application No. 61/371,588, filed Aug. 6, 2010, entitled “Web-Based Cross-Platform Smartphone Applications Creation and Management System” which application is incorporated herein by reference.

### BACKGROUND OF THE INVENTION

With the advent and proliferation of tablet and smart phone devices, demand to quickly and efficiently develop applications (“apps”) which are compatible with the various mobile platforms has exploded. However, developing applications for mobile platforms is, for all practical purposes, more complex than building websites in HTML (which are standardized for use by, for example, a desktop or laptop computer using an Internet browser). In contrast, each mobile device has a unique set of hardware, software and form factor specifications that impact application development and must be considered in order to create an application suitable for a particular mobile platform. Currently each mobile application is developed with an internal and complete workflow, and each application must be customized, along with its internal and complete workflow, for each platform with which the application is intended to operate.

Challenges in creating mobile applications include, for example, the need for development skills and knowledge of multiple device platforms, expertise in social networking and distribution, an ability to integrate with various data sources, content mapping and aggregation of data from various sources, and ability to manage application content, and structure dynamically. Developing and managing smart phone applications for different device platforms (e.g., Apple®, Android™, Blackberry®, etc.) each of which has different operating systems and computer hardware resources thus is a complex and expensive proposition for most content owners (publishers and promoters). A content mapping and aggregation system would be an important feature to enable content delivery to various form factors and electronic platforms. A system that can curate and manage the mapped and aggregated content would also be useful. Further, in order to provide a native experience on various form factors a layout process that is completely disengaged from the data would also a desirable feature. Such unique requirements of mobile publishing render the existing publishing systems for web and print ineffectual.

What is needed is an efficient mechanism for creating and managing smart phone applications that are flexible enough to be deployed across a variety of device platforms.

### SUMMARY OF THE INVENTION

The applications are akin to news and media websites available on the Internet in that the applications provide the latest content, richest media experience and an evolving community around a particular brand. The disclosure provides an efficient and inexpensive process and system for creating and managing of software applications for multiple mobile platforms via an online platform. The systems and processes facilitate creation of applications which communicate with a workflow implemented and powered by an online server. The applications are simple containers that request content from a server based on a token that is preinstalled into the application. Based on the specifications of the device making the request, the token content is preprocessed and served to the application in a format suitable for the receiving device. Content is served to various form factors from an online server by aggregating the content having differing formats at a data level and mapping it into a unified content model. The content can then be edited and curated or listed using workflow process for various types of applications (publishing and promotions). Various application content usage, consumption patterns, location analytics and personalization are recorded. Using these analytics across various app content can be served in new and interesting ways. The analytics forms could, for example, be used for cross promoting content and advertising.

The systems and methods of the disclosure provide for a cloud-based platform to create and manage a mobile presence. The systems and methods provide content mapping, aggregation, curation, and analytics based content listing or curation and delivery. Additionally, the systems and methods provide data connectors with a variety of feeds, XML, JSON, Restful API, web services, CSV files, and force.com. The systems and methods provide a rich and flexible platform upon which to manage content and branding, while easily enable reconfiguration of structure and navigation, with a flexible client architecture to manage a social layer, rich media, and API. The systems and method provide feature integration with public API and open-Auth. The systems and methods facilitate the use of multiple devices, including, but not limited to, for example, HTML5, iPhone®, Android™, iPad® (tablets), and Blackberry®.

An aspect of the disclosure is directed to a mobile application development tool stored in a memory to generate an application. The mobile application development tool comprises: an application creation module adaptable and configurable to generate a mobile application for delivery to one or more mobile devices wherein each of the one or more mobile devices has a device platform and wherein the mobile application identifies one or more feed sources of information; a content processor adaptable and configurable to format the one or more sources of information in a mobile device specific format prior to delivery to the one or more mobile devices; a feed server adaptable and configurable to continuously or near continuously obtain, update and deliver content from the one or more feed sources to the mobile devices. In at least some aspects, the application creation module is adaptable and configurable to at least one or more of assess an application name for uniqueness, to assign a URL to the app, to generate an application in one or more languages, and accept an application description and accept one or more application tags. In still other aspects, the feed sources of the application development tool are selected from the group comprising RSS, RDF, ATOM, and media RSS. Additionally, the feed sources can include services and further wherein the services are selected from the group comprising Twitter, Flickr, Blogger, Wordpress, Webshots and YouTube and any other social web services. The feed sources could also be files in the format of text files, excel files, CSV, JSON, XML, Restful API, and Web-Services. In some configurations, an application post component configurable to communicate a post having one or more of a title, content, image, link, and category. Additionally, an interface adaptable and configurable to display the mobile application in a plurality of mobile platform configurations can also be provided. An analytics module adaptable and configurable to provide one or more data elements selected from the group comprising number of apps downloaded, number of apps downloaded by platform, time, and language, number of application views, and number of apps viewed by platform, time, and language.

Another aspect of the disclosure is directed to a method for mobile application development. The method comprises, for example: creating a mobile application using an application creation module adaptable and configurable to generate a mobile application for delivery to one or more mobile devices wherein each of the one or more mobile devices has a device platform wherein the mobile application identifies one or more feed sources of information; processing content for delivery via the mobile application with a content processor adaptable and configurable to format the one or more sources of information in a mobile device specific format prior to delivery to the one or more mobile devices; configuring the mobile application for one or more mobile devices at an application server; and publishing the mobile application via the Internet. In some aspects of the method, one or more of the following steps are performed: the mobile application has a name and further comprising the step of assessing an application name for uniqueness, assigning a URL to the app, generating an application in one or more languages, accepting an application description and accepting one or more application tags, selecting the one or more sources from the group comprising RSS, RDF, ATOM, and media RSS, selecting the services from the group comprising Twitter, Flickr, Blogger, Wordpress, Webshots and YouTube, and providing a posting having one or more of a title, content, image, link, and category. In at least some aspects the method can further comprise analyzing one or more application data elements selected from the group comprising number of apps downloaded, number of apps downloaded by platform, time, and language, number of application views, and number of apps viewed by platform, time, and language. Ins till other aspects, the method comprises the step of generating a token and installing the token into the mobile application prior to delivering the application to an end user mobile device.

Still another aspect of the disclosure is directed to a method for maintaining a mobile application. The method of maintaining the mobile application comprises: processing content from one or more sources of information for delivery via a mobile application with a content processor adaptable and configurable to format the one or more sources of information for delivery to one or more mobile devices wherein each of the one or more mobile devices has a device platform; configuring the content for the mobile device platform on a server without interaction with the mobile application receiving device; and continuously or near continuously at least one of obtaining, updating and delivering content from the one or more feed sources to the mobile device based on device configuration information contained in a mobile device token. Additional aspects can further comprise providing a posting having one or more of a title, content, image, link, and category. Still other aspects can include analyzing one or more application data elements selected from the group comprising number of apps downloaded, number of apps downloaded by platform, time, and language, number of application views, and number of apps viewed by platform, time, and language and/or configuring the content from a plurality of sources in a plurality of formats for delivery to the mobile device.

Another aspect of the disclosure is directed to a networked apparatus comprising: a memory; a processor; a communicator; a display; and an application creation module adaptable and configurable to generate a mobile application for delivery to one or more mobile devices wherein each of the one or more mobile devices has a device platform wherein the mobile application identifies one or more feed sources of information, a content processor adaptable and configurable to format the one or more sources of information in a mobile device specific format prior to delivery to the one or more mobile devices, a feed server adaptable and configurable to continuously or near continuously obtain, update and deliver content from the one or more feed sources.

Still another aspect of the disclosure is directed to a networked apparatus comprising: a memory; a processor; a communicator; a display; and an application maintenance module adaptable and configurable to process content adaptable and configurable to format one or more sources of information in a mobile device specific format prior to delivery to the one or more mobile devices, and a feed server adaptable and configurable to continuously or near continuously obtain, update and deliver content from the one or more feed sources.

Yet another aspect of the disclosure is directed to a mobile application maintenance tool stored in a memory. The mobile application maintenance tool is adaptable and configurable to provide an application maintenance module adaptable and configurable to update a mobile application for delivery to one or more mobile devices wherein each of the one or more mobile devices has a device platform wherein the mobile application identifies one or more feed sources of information; a content processor adaptable and configurable to format the one or more sources of information in a mobile device specific format prior to delivery to the one or more mobile devices; and a feed server adaptable and configurable to continuously or near continuously obtain, update and deliver content from the one or more feed sources. The mobile application maintenance tool can operation automatically or semi-automatically.

Still another aspect of the disclosure is directed to a non-transitory, computer-readable storage media for tangibly storing thereon computer readable instructions for a method comprising: receiving a request from a mobile device; a mobile application communicating the request to a server causing the server to identify a mobile device type; in response to identifying the mobile device type, delivering information to the mobile device in a format suitable for display on a mobile device interface.

Another aspect of the disclosure is directed to a mobile application mapping system stored in a memory comprising: a dynamically configurable content mapping system adaptable and configurable to format one or more sources of content for delivery to one or more mobile devices wherein each of the one or more mobile devices has a device platform in a format adaptable and configurable for display on each of the mobile device platforms prior to delivery to the one or more mobile devices; and a feed server adaptable and configurable to continuously or near continuously obtain, update and deliver content from the one or more sources of content to the one or more mobile devices. In some aspects, the mobile application mapping system is adaptable and configurable to process one or more sources of content are selected from the group comprising RSS, RDF, ATOM, and media RSS. Additionally, the one or more sources of content are services and further wherein the services are selected from the group comprising Twitter, Flickr, Blogger, Wordpress, Webshots and YouTube and any other social web services. Additionally, the dynamically configurable content mapping system is adaptable and configurable to apply one or more tags to the one or more sources of content. Moreover, the feed server is further adaptable and configurable to aggregate data from the one or more sources of content based on the one or more tags applied to the one or more sources of content.

Still another aspect of the disclosure is directed to an interface module stored in a memory comprising: a content mapping system adaptable and configurable to format one or more sources of content for delivery using standard compliant scripting language to one or more mobile devices having one or more mobile device platforms in a format adaptable and configurable for display on each of the mobile device platforms prior to delivery to the one or more mobile devices; and a feed server adaptable and configurable to obtain, update and deliver content from the one or more sources of content to the one or more mobile devices. In at least some aspects, the one or more sources of content are selected from the group comprising RSS, RDF, ATOM, and media RSS. Additionally, the one or more sources of content are services and further wherein the services are selected from the group comprising Twitter, Flickr, Blogger, Wordpress, Webshots and YouTube and any other social web services. In some configurations, the content mapping system is adaptable and configurable apply one or more tags to the one or more sources of content. Additionally, the feed server is further adaptable and configurable to aggregate data from the one or more sources of content based on the one or more tags applied to the one or more sources of content. The standards compliant scripting language is one or more of HTML, CSS and Java Scipt. Additionally, a content curator can be provided that is adaptable and configurable to curate content from a plurality of content sources having one or more content formats into a unified format for delivery to the mobile devices.

Yet another aspect of the disclosure is directed to a system comprising: a flexible client architecture comprising a client interface shell, a navigation controller, a template caching apparatus, a data caching apparatus, one or more of a native viewer, an editor, a player, and a transition animator stored on a memory; a mobile content management system adaptable and configurable to provide one or more of content models, templates, analytics, monetization, and device profiles stored on a memory; a publisher syndicator stored on a memory; a content aggregator including one or more of a queue server, a fetch server, and a parse server, wherein the flexible client architecture is adaptable and configurable to be in communication with the mobile content management system via a cloud server. Additional aspects can further comprise a mobile application mapping system stored in a memory comprising a dynamically configurable content mapping system adaptable and configurable to format one or more sources of content for delivery to one or more mobile devices having one or more mobile device platforms in a format adaptable and configurable for display on each of the mobile device platforms prior to delivery to the one or more mobile devices; a feed server adaptable and configurable to continuously or near continuously obtain, update and deliver content from the one or more sources of content to the one or more mobile devices. In some instances, the one or more sources of content are selected from the group comprising RSS, RDF, ATOM, and media RSS. Additionally, the one or more sources of content are services and further wherein the services are selected from the group comprising Twitter, Flickr, Blogger, Wordpress, Webshots and YouTube and any other social web services. In other aspects of the disclosure, the dynamically configurable content mapping system adaptable and configurable apply one or more tags to the one or more sources of content. In at least some configurations, the feed server is further adaptable and configurable to aggregate data from the one or more sources of content based on the one or more tags applied to the one or more sources of content.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

References that might be useful for understanding the disclosure include, for example, U.S. Pat. Nos. 7,133,874 B2 to Hill et al. for Prototyping Model for Components of a Software Program, 7,188,158 B1 to Stanton, et al. for System and Method for Component-Based Software Development, 7,966,578 B2 to Tomalsky et al. for Portable Multifunction Device, Method, and Graphical User Interface for Translating Displayed Content, 7,870,075 B1 to Sabet for System and Method for Managing Software Development, 7,784,030 B2 to Christfort et al. for Developing Applications Online, 7,765,535 B2 to Haraguchi et al. for Software Development Tool Program. 7,711,740 B2 to Minore et al. for Data Access Layer Design and Code Generation; U.S. Patent Publication US 2010/0192123 A1 to Carey et al. for Software Development for a Hybrid Computing Environment; US 2010/0037024 A1 to Lin et al. for Content Distribution for Mobile Device; and PCT Publication WO 2010/017098 A2 to Lin for Content Distribution for Mobile Device, and WO 2009/035397 A2 to Park et al. for System for Developing Software.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which web-based cross-platform smart phone application creation and management can be achieved as would be known in the art;

FIG. 1B is a block diagram of an exemplary computing environment through which web-based cross-platform smart phone application creation and management can be achieved as would be known in the art;

FIG. 1C is an illustrative architectural diagram showing some structure that can be employed by devices through which web-based cross-platform smart phone application creation and management is achieved as would be known in the art;

FIG. 2 is a block diagram showing the cooperation of exemplary components of a system suitable for use in a system where web-based cross-platform smart phone application creation and management is achieved as would be known in the art;

FIG. 3 is a diagram illustrating the website architecture for the disclosed systems and methods;

FIGS. 4A-B are diagrams illustrating the process of creating and maintaining applications; and the flow of information for updating and publishing an application for the disclosed systems and methods;

FIGS. 5A-E illustrate exemplar interfaces for the disclosed systems and methods;

FIG. 6 is a diagram of the system architecture for the disclosed systems and methods;

FIG. 7 provides a high level overview of the system component; and

FIGS. 8A-B are a diagram of feed server and app support server.

### DETAILED DESCRIPTION OF THE INVENTION

### I. Computing Systems

The web-based cross-platform smart phone application creation and management systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how the web-based cross-platform smart phone application creation and management system operates an understanding of suitable computing systems is useful. The web-based cross-platform smart phone application creation and management systems and methods disclosed herein are enabled as a result of application via a suitable computing system.

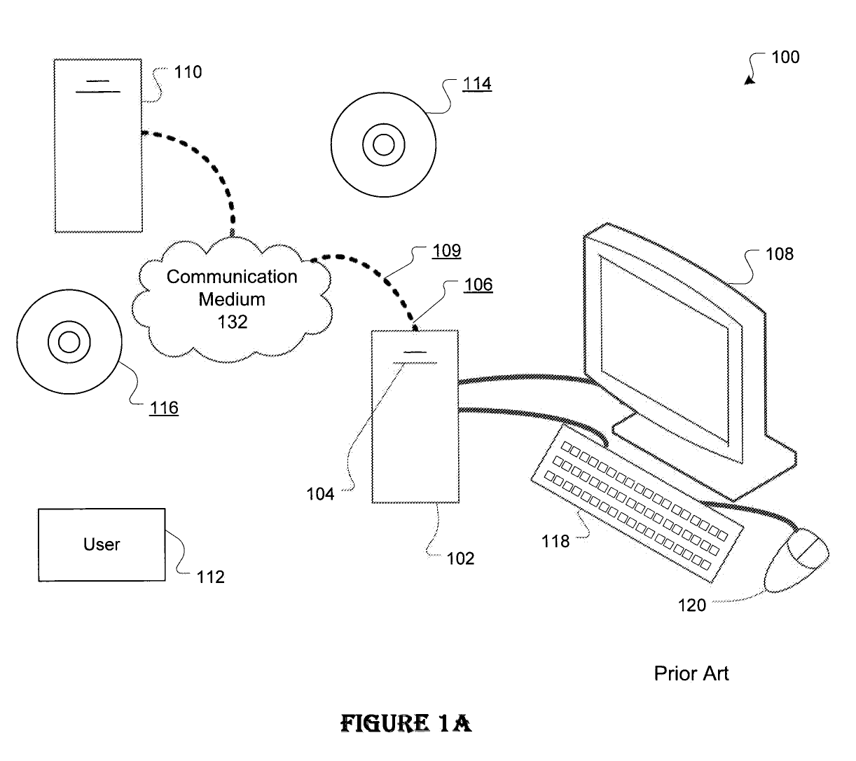

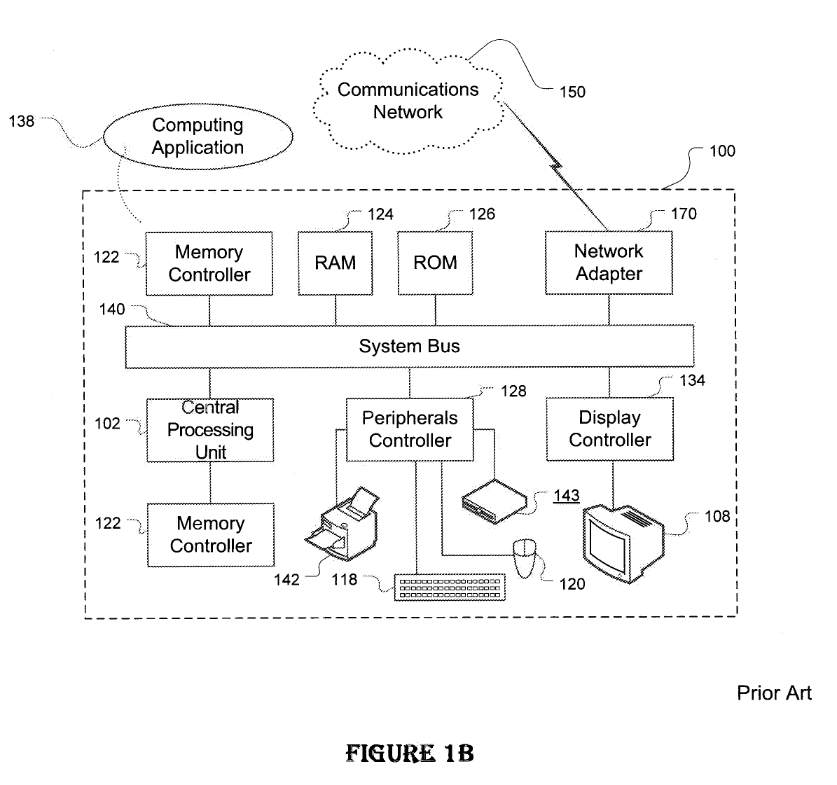

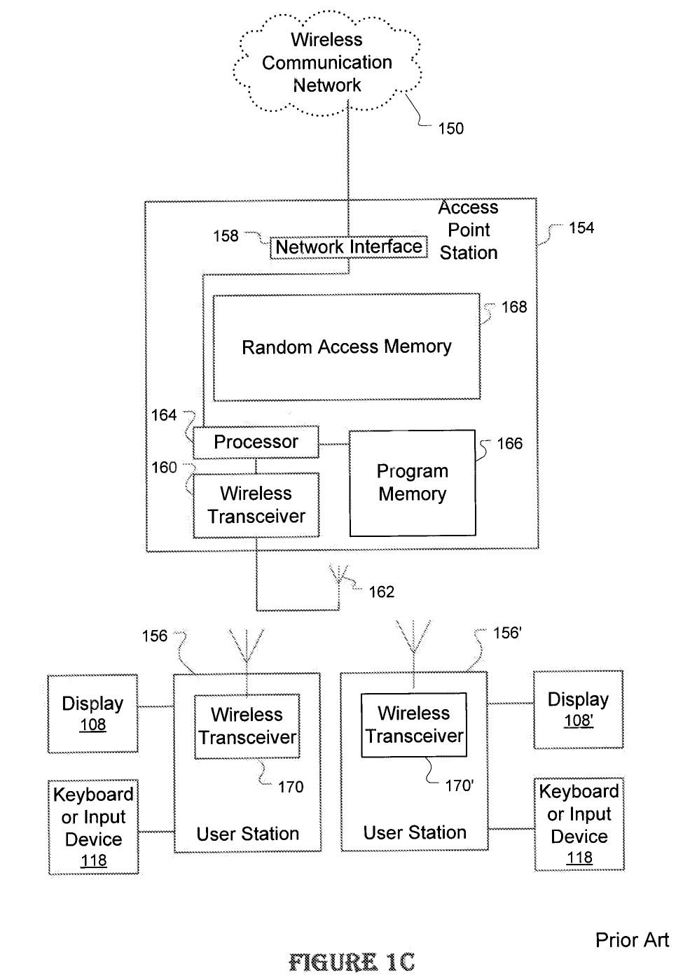

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and can have a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an Internet connection. It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the disclosure. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

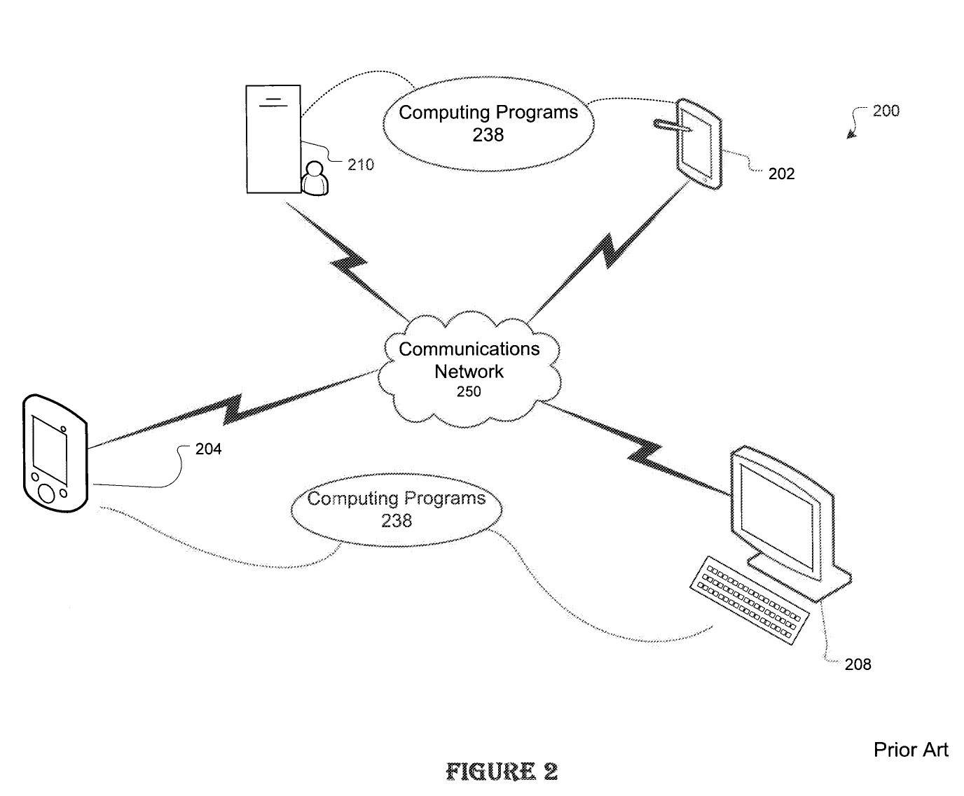

As will be appreciated by those skilled in the art, a cloud server can be used in the networked environment and refers to the use of cloud computing which refers to a logical computational resources (data, software) accessible via a computer network (through WAN or Internet etc. as described above with respect to FIGS. 1-2), rather than from a local computer. Data are stored on, for example, server farms generally located in the country of the service provider. The on-line service is offered from a cloud provider. A cloud user needs a client device such as a laptop or desktop computer, pad computer, smart phone, or other computing resource with a web browser (or other approved access route) to access a cloud system via the World Wide Web. Typically the user will log into the cloud at a service provider or private company, such as their employer. Cloud computing works on a client-server basis, using web browser protocols. The cloud provides server-based applications and all data services to the user, with output displayed on the client device. If the user wishes to create a document using a word processor, for example, the cloud provides a suitable application running on the server which displays work done by the user on the client web browser display. Memory allocated to the client system's web browser is used to make the application data appear on the client system display, but all computations and changes are recorded by the server, and final results including files created or altered are permanently stored on the cloud servers. Performance of the cloud application is dependent upon the network access, speed and reliability as well as the processing speed of the client device.

Since cloud services are web-based, they work on multiple platforms, including Linux, Macintosh, and Windows computers. Smart phones, pads and tablet devices with Internet and World Wide Web access also provide cloud services to telecommuting and mobile users. A service provider may pool the processing power of multiple remote computers in a cloud to achieve routine tasks such as backing up of large amounts of data, word processing, or computationally intensive work. These tasks might normally be difficult, time consuming, or expensive for an individual user or a small company to accomplish, especially with limited computing resources and funds. With cloud computing, clients require only a simple computer, such as net books, designed with cloud computing in mind, or even a smart phone, with a connection to the Internet, or a company network, in order to make requests to and receive data from the cloud, hence the term software as a service (SaaS). Computation and storage is divided among the remote computers in order to handle large volumes of both, thus the client need not purchase expensive hardware or software to handle the task. The outcome of the processing task is returned to the client over the network, dependent on the speed of the Internet connection.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the disclosure.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MID5), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems and technical effect of this disclosure, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

### IV. Media Independent Handover Services

In IEEE P802.21/D.01.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

The computer implemented systems provide a storage and delivery base which allows users to exchange services and information openly on the Internet used to achieve the desired technical effect and transformation. A user will be enabled to operate as both a consumer and producer of any and all digital content or information through one or more master system servers.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices.

When an app creator, creates the application, the application, for example, be created using a browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A application creator can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

Computing system 100, described above, can be deployed as part of a computer network used to achieve the desired technical effect and transformation. In general, the above description for computing environments applies to both server computers and client computers deployed in a network environment. FIG. 2 illustrates an exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual private network, the Internet, or other communications network) with a number of client computing environments such as a smart phone 204, personal computer 208, and personal digital assistant or tablet 202. In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 200 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VI. Media Independent Information Service

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

### VII. Software Programs Implementable in the Computing and Network Environments to Achieve a Desired Technical Effect or Transformation

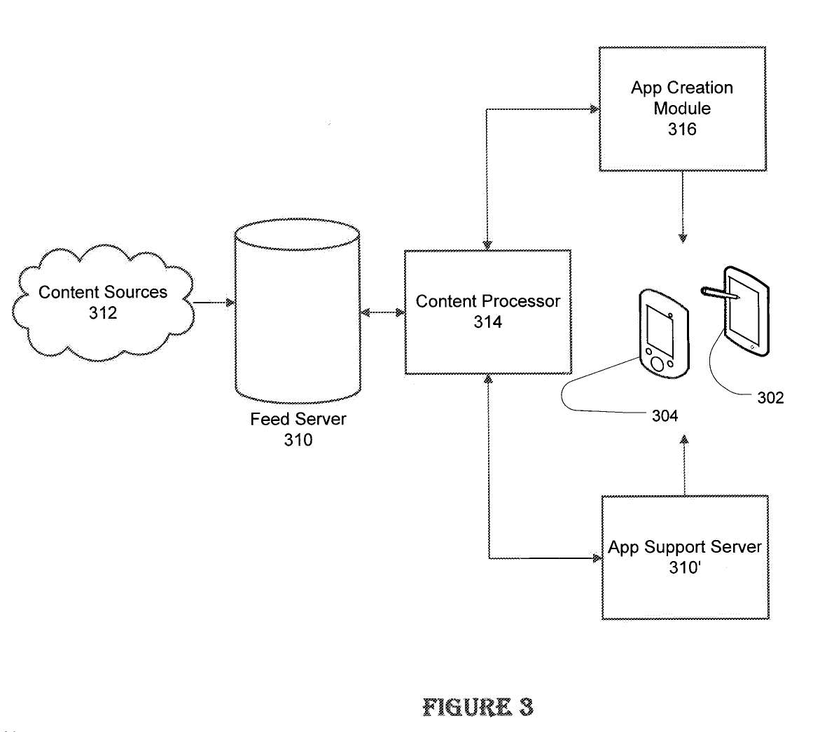

FIG. 3 is a diagram illustrating an overview of the architecture of a system according to the disclosure that provides content from one or more content sources to a user or client from a provider or application (“app”) creator, wherein the news and media is configured for optimized presentation or delivery to a specified platform prior to delivery. A variety of content sources 312 are accessible by a feed server 310. Feed server 310 is configurable to continuously, or nearly continuously, fetch and update content from feed sources 312. As will be appreciated by those skilled in the art, the various feed sources include, but are not limited to, data available from various XML (extensible markup language) formats, such as Real Simple Syndication (RSS), Resource Description Framework (RDF), ATOM, and Media RSS, to name a few. Each feed syndicated from a feed sources is a stream of information. Typically different attributes are associated with the information such as a title, description, tags, categories, permanent website links, media links (audio and video), media formats (mp3, flash), media attributes (frame rate, bit rate, length), and media players, among others. The feed server 310 parses the various feed source formats and attributes from the crawled data using a content dynamic parsing server and a content mapping system 314 and stores the data into a local content model. The content model is stored, for example in a local database. As will be appreciated by those skilled in the art, the parser and content mapping features can be part of the crawling system. The parser and content mapping forms part of a content processor, or mobile content management system (mCMS). The installed application (i.e., the application that has been installed on a smart phone, tablet or other mobile device), sends or transmits a content request to the application support server 310′ along with an identification of the device specifications for the user's mobile device and the token. The application support server 310′ then delivers content obtained from the content sources 312 through the feed server 312, and content processor 314, to the application residing on the user's device, e.g. smart phone 308 or tablet 302. User, such as user 112 shown in FIG. 1, accesses the system and can use apps that have been created; application creators create and maintain apps via an application creation module 316 which can store the apps for download into a mobile device. As will be appreciated by those skilled in the art, users and application creators can be the same or different persons.

A token is, for example, a pair of unique identification numbers generated by the content processor when an application is created. The unique identification numbers includes a publisher or app creator identification and an app identification number. The token is preinstalled into the app and resides within the app at the time of installing the app on an end user device. Each time an app is launched anew (not just change state from a sleeping state to an active state) the app sends the token to the app support server. Along with the token, the app sends a unique device identification number for the end user device, which identifies the type of the device and any relevant platform information (e.g., iPhone, Android, iPad, browser etc.), physical location in the form of latitude and longitude where the app is used.

The parsing of various formats and attributes plays a critical role in delivering the appropriate content based on device specifications. The application content processor 314 is configurable such that it can deliver a media object in, for example, Adobe® Flash format and match it to, for example, the iPhone®, that requested it. The application content processor 314 is also configurable such that it can detect and identify a request submitted by, for example, an iPhone®, assess the formats compatible with the iPhone® to determine that the iPhone cannot play a flash file, and then not present the incompatible file to the device.

With this approach, the application design and application functionality become independent of the hardware and software specifications of the device. For example, the content rendering and branding elements are also independent of the device form factor. Maintaining the workflow on the application support server 310′ also helps to implement a robust and scalable content aggregation system that is configurable to provide the latest content. Furthermore the methods and processes described herein provide a layer of control for an application creator, helping them to revise the application (e.g., the design, content, curation, and branding elements) easily and on-the-fly.

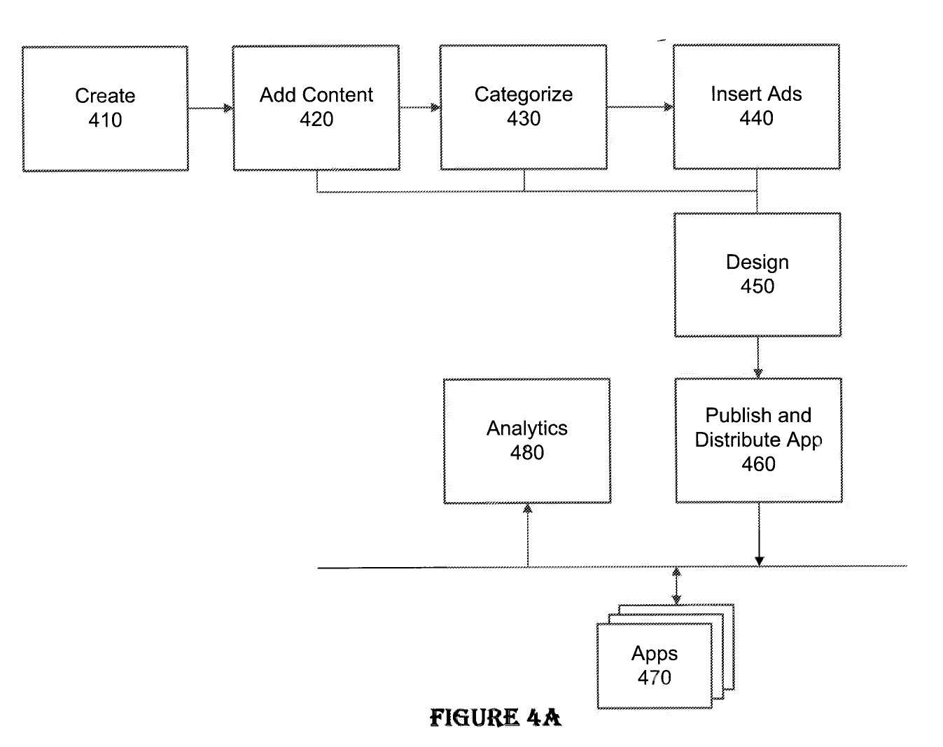

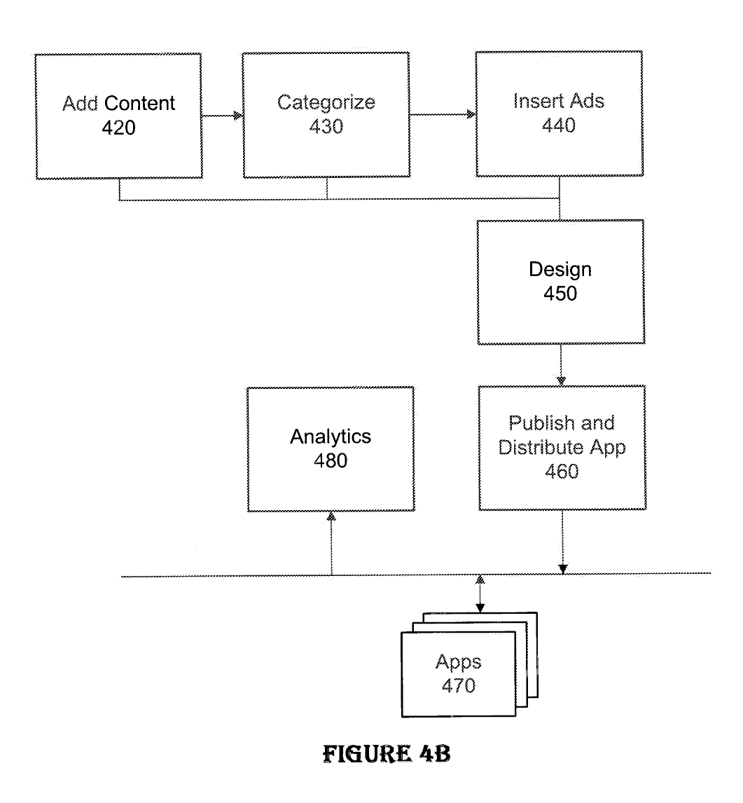

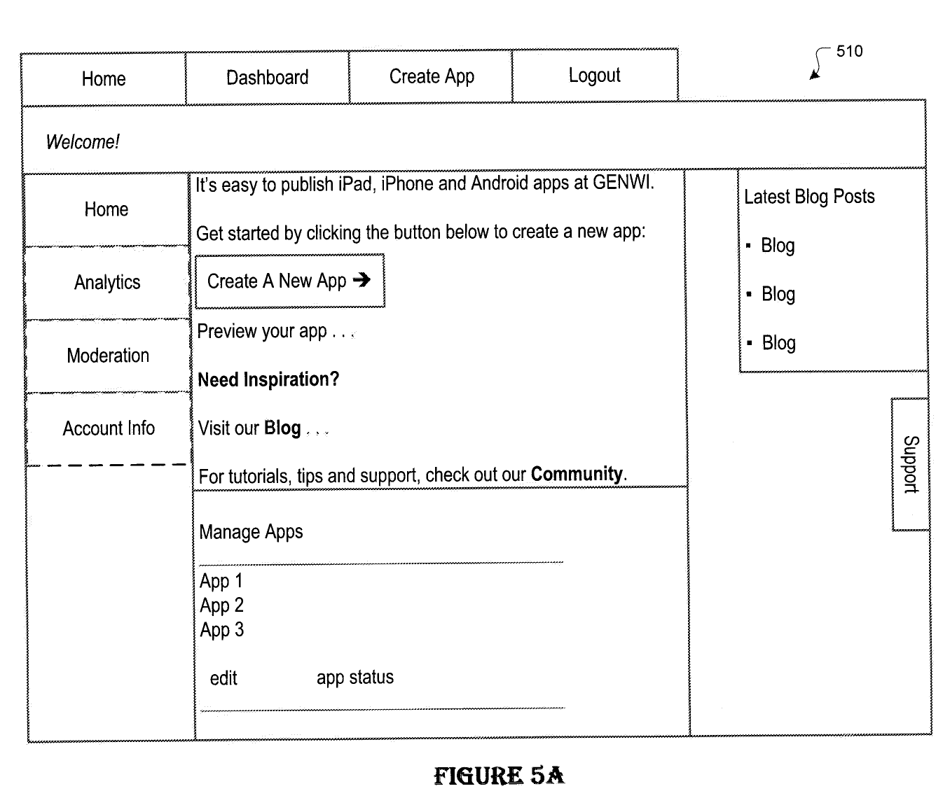

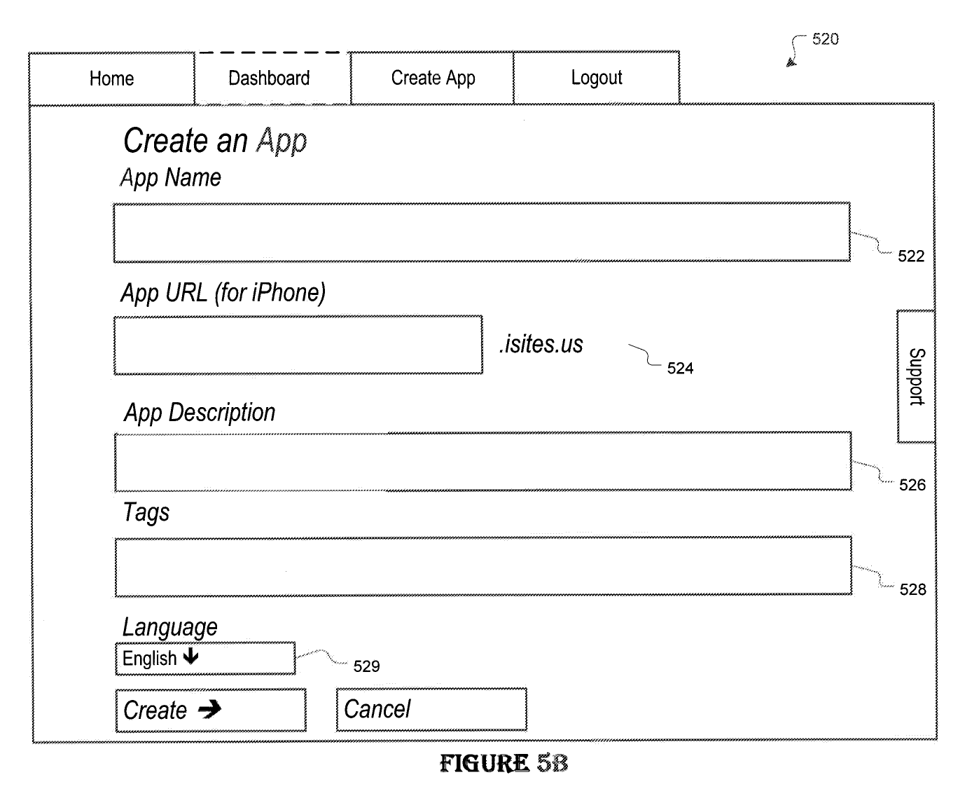

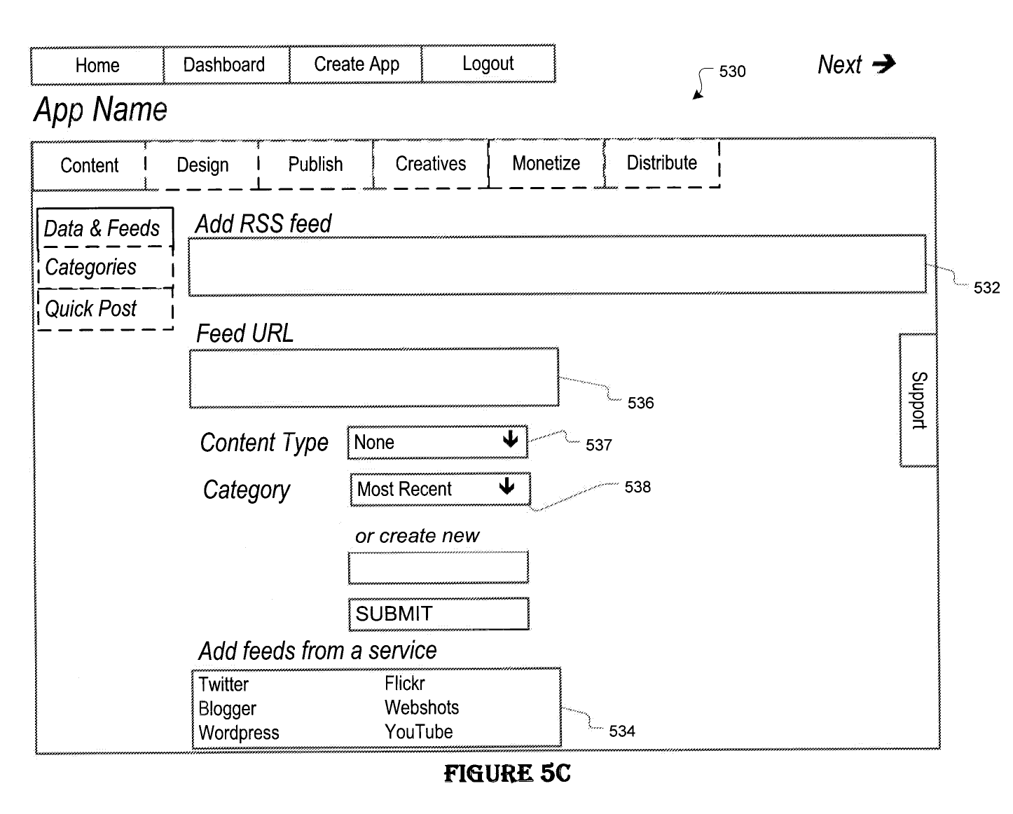

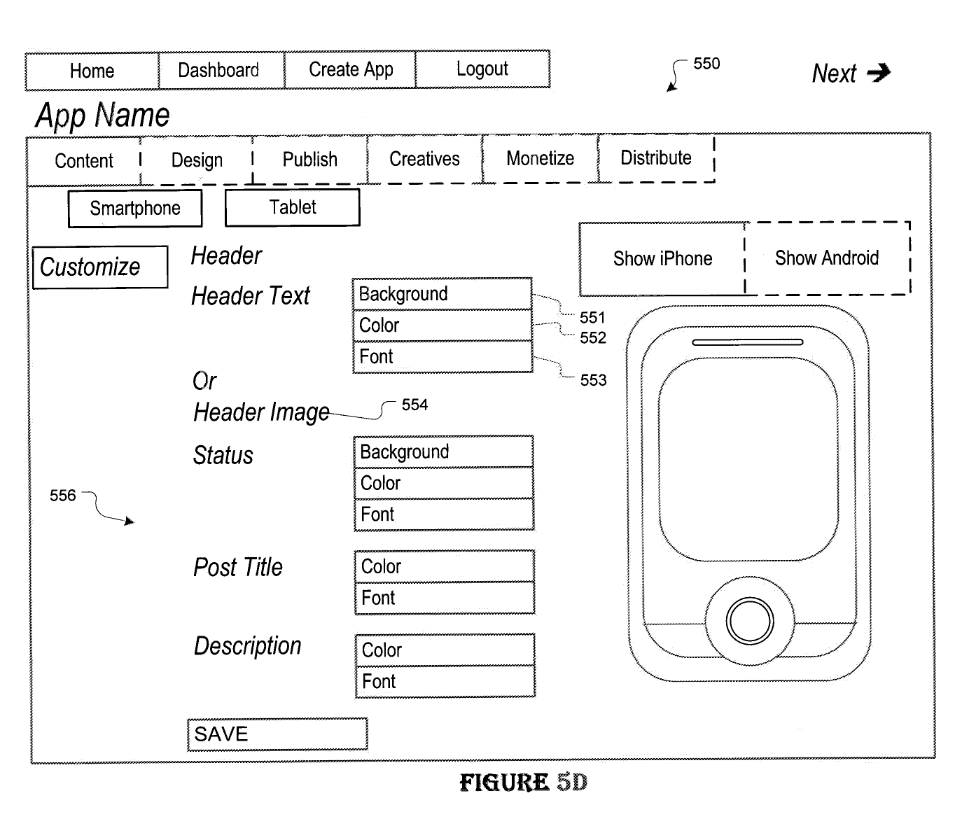

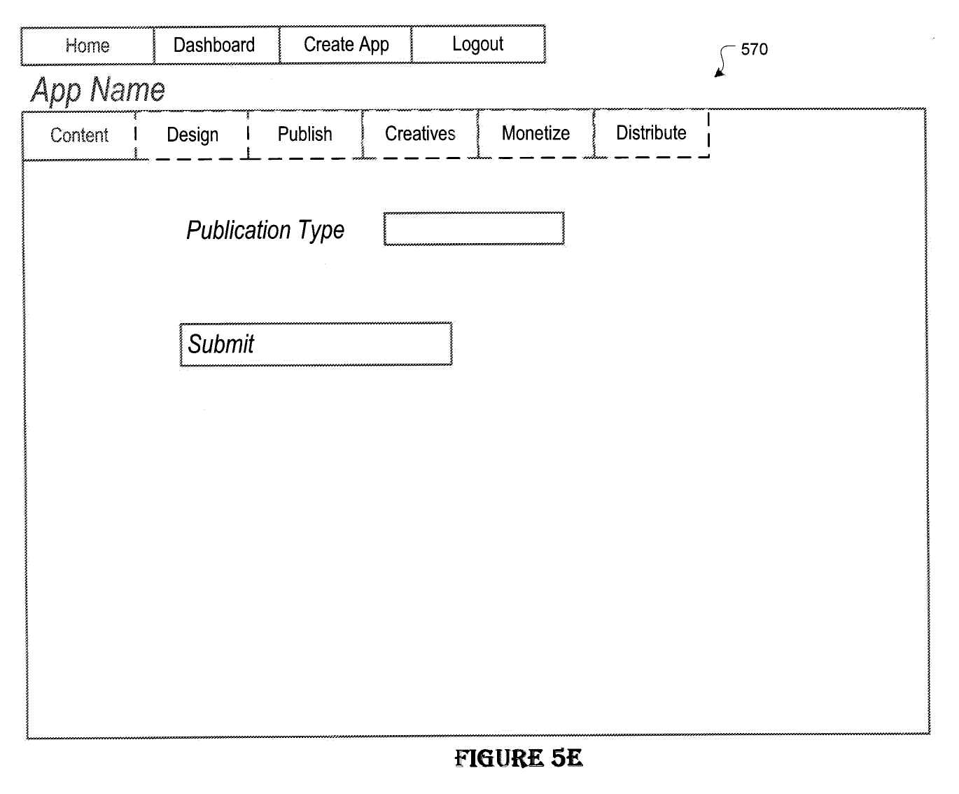

FIGS. 4A-B are diagrams illustrating a process of creating an application; and the flow of information for updating and publishing an application. FIGS. 5A-E illustrate exemplar interfaces that would be encountered by an application creator in creating and/or maintaining an application according to this disclosure. FIG. 5A illustrates a home screen; FIG. 5B illustrates an application creation screen. FIG. 5C illustrates a content screen for adding feeds and adding posts which would be seen at either creation or editing of an app. FIG. 5D illustrates a design screen for customizing the appearance of the application and the categorization of the application for either a new application or an existing app. As will be appreciated by those skilled in the art, the app can be designed for either a smart phone format (e.g., iPhone, Android), or a tablet (e.g. iPad) format. An application creator can select to see the application displayed on an iPhone or an Android, for example. FIG. 5E illustrates a publish screen which enables the application creator to publish the new or updated application in an application store.

The architecture described in FIG. 3 provides a flexible mechanism and platform upon which to create and manage smart device applications. Other system architectures can be employed without departing from the scope of the disclosure. A user, application creator, or publisher, can create an application profile or design and simulate the application experiences on the application creation module 316. After adding content and customizing the application with, for example, branding elements, the application creator can view the simulated application as it will appear on a variety of smart device platforms from the application creation module 316. In a first step, an application creator creates an application 410. A sample home page 510 and initial application creation page 520 is shown in FIG. 5A. The application creation process can include providing an application name 522, which is, for example, a 14 character name that can be used as a title when the application is downloaded from an application store. Optionally, the application name can be checked against existing apps on a central server to ensure the application name is unique. If the application name check process is followed, once the application name has confirmed as unique, a URL for the application is assigned 524, e.g., an application name of 4 patent could be assigned a URL 4patent.isites.us or 4patent.genwi.com. In an alternative configuration, the application creator can select a unique URL or a unique URL can be assigned for the app. From there an application description is provided. The application description 526 is a searchable description that is configurable to appear in a master index or gallery (e.g., description of the application provided on the Android Market app store). Tags 528 can also be added to facilitate discoverability of the application in the target app store. Tags take the form of key words. Additionally, the application creator can select a language 529 for the app.

Once the creation step is completed, the application creator then adds content 420 to the app. For example, the application creator can add at a content page 530 one or more RSS feeds 532, e.g., from an application creator's own website, or forum, or favorite blogs and new sites at an RSS Feed interface (shown in FIG. 5C). The feeds can be RSS, XML, and Atom, for example and can be added from a variety of services 534. The feeds can be added by, for example, typing in the feed URL 536. Feed validity can be determined by the application creator or the system. The feed can then be characterized by one or more of content type 537 and category 430, 538, where the application creator can maintain a category list. Feeds can also be added from services such as Twitter™, Blogger, Wordpress.com, Tumblr, Posterous, Flickr, Webshots, Picasa, Smugmug, and YouTube, or any other desired source. A plurality of Twitter names can be added to the list for the Twitter feed. Additionally, a buzz section can be added associated with the Twitter names that represent one or more Twitter users. Keywords can also be excluded. Data and feeds can also be added in various other formats such as CSV, JSON, XML, Excel, Resful API's, and Webservices. Posts can also be added. The posts include, for example, a title, content, image, media link, media link type, category selected from an existing category, or create a new category. Additionally, the application creator can edit existing posts. As will be appreciated by those skilled in the art, additional configuration options, beyond those described herein, can be included without departing from the scope of the disclosure. The application creator can create, update and manage an application which is deliverable to a variety of mobile platforms without writing any code or having any particular knowledge of the various mobile platform configurations. As a mobile platform changes, the created application will adapt to those changes from the server side and will continue to deliver the application to the user in a format that maximizes presentation of the information provided.

Once content is added, an application creator can then optionally design the application 450 at an application design screen 550 for one or more appropriate platforms or select a default design for one or more platforms, e.g. smart phones (iPhone, Android) and tablets (iPad). In designing the app, an application creator can select, for example, a background 551, a color 552, a font style 553, for a header, and a header image 554, etc. Moreover, background, color and font can be individualized for different portions of the application including, for example, the header, the status, the post title, and the description. In some configurations, an image of the appearance of the application on a selected platform 556 is then selectable. The image is configurable to display the platform along with a visual representation of how the application will be displayed on the device. Additional categories can be added. Advanced users can design a specific layout for custom content structure. Selecting pre-created templates can do this or creating custom templates using well know standards such as HTML5 and CSS3. The layout can be further customized based on custom font families, colors, sizes and spacing. Based on type of the content various layouts can be chosen. For example video listing would be different than audio or classifieds listings.

Once the application is designed 450, the application can then be published 470 as shown, for example, in the publication page 570 shown in FIG. SE. Also, once the application publishes the application resides on a publicly accessible server with a plurality of apps 470 created by the application creator or other application creators. The publication step can also include the step of choosing location of publication (e.g., app stores), length of publication, cost of publication, and any other suitable settings.

After the app is published, a user can incorporate ads from various ad networks or can elect to have ads automatically added to the app, or to have ads that are relevant to the subject matter of the app added on a targeted basis. The user can enable one of the several ad networks by adding the corresponding ad network identification. The user can stop or start the ads being served from the ad network into the app directly from the mCMS or app creator. Other in-built in monetization features such as coupons and deals can also be listed which will appear in the app for the duration based on the start and expiration dates. Such coupons listed could be served into the app based on the user location that is known through the Token sent by the app (at the start of the app and while viewing content).

An application creator can also check the analytics 470 for a particular application once it has been published. The analytics can include, for example, number of application downloads for a particular app, number of application views for a particular app, and popular content. Moreover, downloads can be categorized by, for example, HTML5 app, iPhone, Android, and iPad as well as by month. As will be appreciated by those skilled in the art, in some configurations, an application creator may skip a step, or leave information at a default value without departing from the scope of the disclosure. For example, the application creator could skip the step of inserting ads 440 prior to publishing. Analytics can be applied in a variety of ways in order to provide inclusive and exclusive information to the app creator. For example, where an app creator has created an app provides a feed of information to an end user that mixes and matches content from a variety of sources (in a variety of formats), the app creator can assess how the information is being used or consumed by the end user based on a variety of analysis. For example, an assessment could be made whether information from a particular source is viewed or not by app users from a particular state or zip code, or whether a particular item of information (article, audio, video) is viewed or not by an app user from a particular state or zip code. Additional metrics can be considered as well including age, gender, ethnicity or any other information provided by an app user or discernable from the app user's mobile device. Additional analytics would allow the app creator to determine which content was the most consumed, the most shared, etc.

Once the application has been created, an application creator can maintain the app, as shown in FIG. 4B by adding, deleting or modifying content, adding, deleting or modifying categories, adding, deleting or modifying inserted ads, and adding, deleting or modifying design parameters. Once the application is updated, the updates are automatically applied within all the apps that were already downloaded and installed on the device without requiring further publishing and resubmission of the app to the app store or reinstallation by the user. The app creation, maintenance, management, republishing, updates, analytics, and any other features can be created and maintained from any computing device including, but not limited to a computer, a tablet computer, and a smart phone.

Once content is added to the app, a feed server continuously fetches the updated content from the feed sources, parses it, and maps it to a predesigned content model and stores it on the local app server.

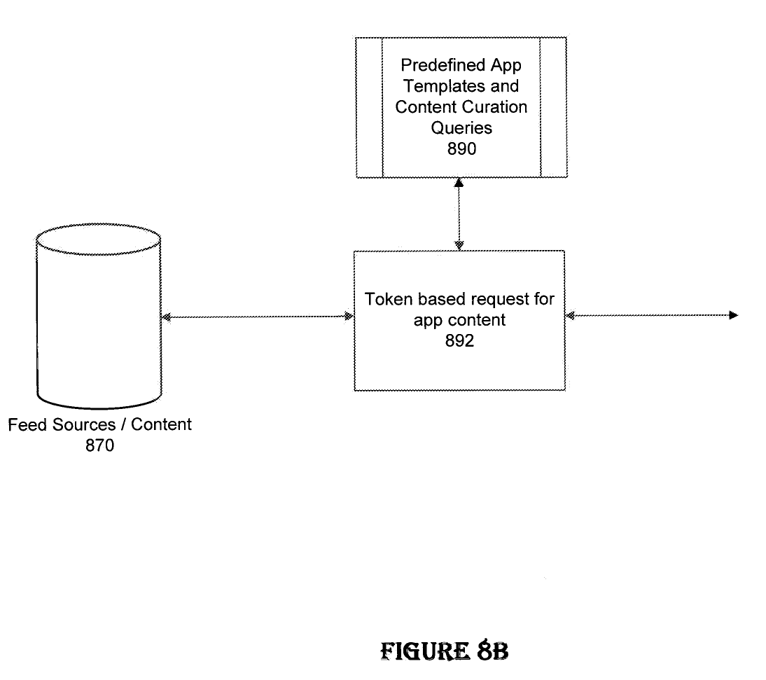

As shown in FIG. 8A, the feed queue is a first part of the feed server 800 cycles through all feed sources continuously and queues them into a feeds queue created using messages queues (message queues are inter-process communication queues provided by the underlying operating system). Each feed source (feeds) is also stored into the queue along with a feed token that identifies the feed sources uniquely in the feed server system. There could be one or multiple feed queues based on the priority of a feed as determined by the application creator server. In order to determine if a feed source needs to be queued for data fetching the feed source is ranked based on a ratio termed as feed rank. The feed rank is defined as of the number of information elements (items within a feed) aggregated and the total time it takes to aggregate the information.

Feed Rank=Number of items aggregated/Duration of aggregation

Once the feed sources are queued into the feeds queue, the feed fetcher, which polls feed queue starts to fetch content from the feed source location. The fetching process is built to auto-rectify or self heal the feed source address based on the HTTP standard. In order to operate at high speed and cycle through millions of feeds the feed server spawns multiple threads. The threads could potentially operate at various priorities that is determined by the quality and refresh rate of the feeds. Each thread utilizes a raw socket in order to improve the speed at which the data is fetched from various sources. Once the data is fetched from a feed source it is stored as blob of data identified by a unique feed token in a new queue terms data queue.

As will be appreciated by those skilled in the art, feed sources data are in various XML (extensible markup language) formats, such as Real Simple Syndication (RSS), Resource Description Framework (RDF), ATOM, and Media RSS, to name a few. Each format has different attributes associated with the information such as a title, description, tags, categories, permanent web links, media links (audio, video), media formats (mp3, flash), media attributes (frame rate, bit rate, length) and media players, among others. The feed sources data is read from the data queue as a blob of data and undergoes a parsing process. The parsing process detects a set of pre-determined tags and the content associated with those tags. The content is then extracted and mapped to a corresponding data element in the app creator system content model. The mapping system can also read a list of tags specified by the app creator that could be read from a configuration file or database (in the form of text or XML file). Each information object or an item or content is then stored in a local database identified by a unique item identification number and feed token number.

The application sends requests to the application creation module server with the device specifications and the token. The application server then delivers the content request along with the device profile to the application content processor. The application content processor matches the request to application content identified by the token, and customization information specified by the publisher. It then delivers it back to the application through the application server.

The parsing of various formats and attributes plays a functional role in delivering the appropriate content based on device specifications. The application content processor can deliver a media object on Adobe Flash format and match it to the Android phone that requested it.

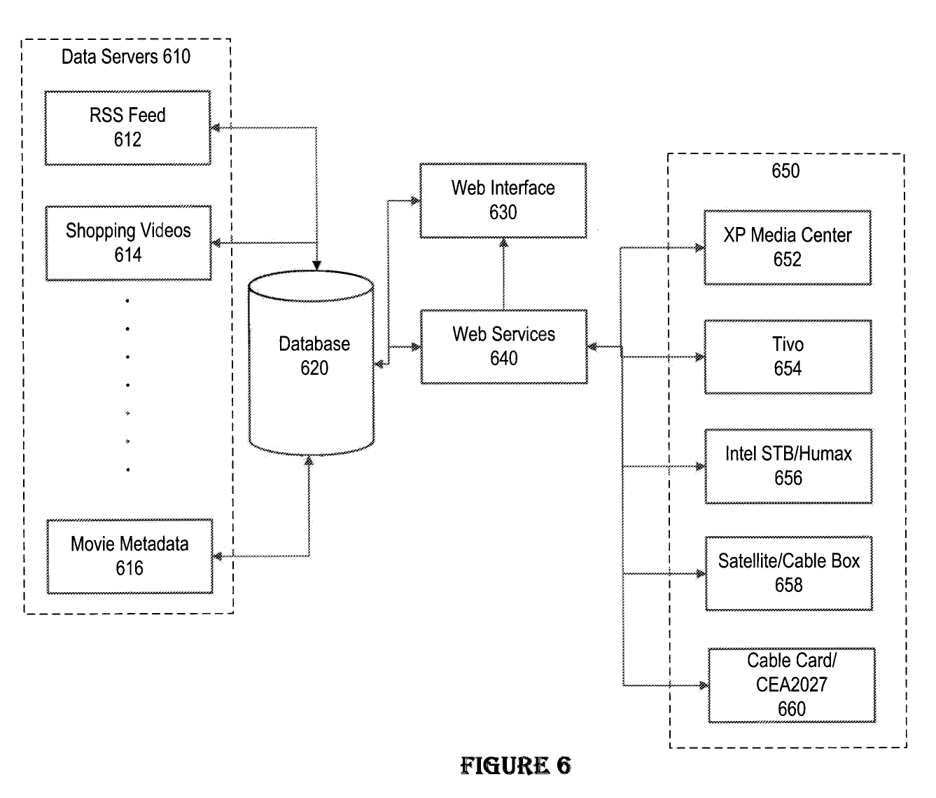

FIG. 6 is a diagram of the system architecture. As illustrates a variety of data sources 610 are in communication with a database 620. The data sources include, for example, RSS Feed 612, shopping videos 614, and movie meta data 616, to name a few. The database 620 is in communication with a web interface 630 and web services 640. Various devices 650 can operate as part of the system including, but not limited to, XP media center 652, TiVo® 654, Intel STB/Humax 656, Satellite/cable box 658, cable card/CEA 2027 660 as well as, for example, Google® TV. The general architecture of the system is configurable to include four parts: web applications and services for collection of metadata; web interface for personalized media play-list creation; web services for play-list delivery based on device characteristics; and smart clients that provided structured data in native client user interface (UI) formats.

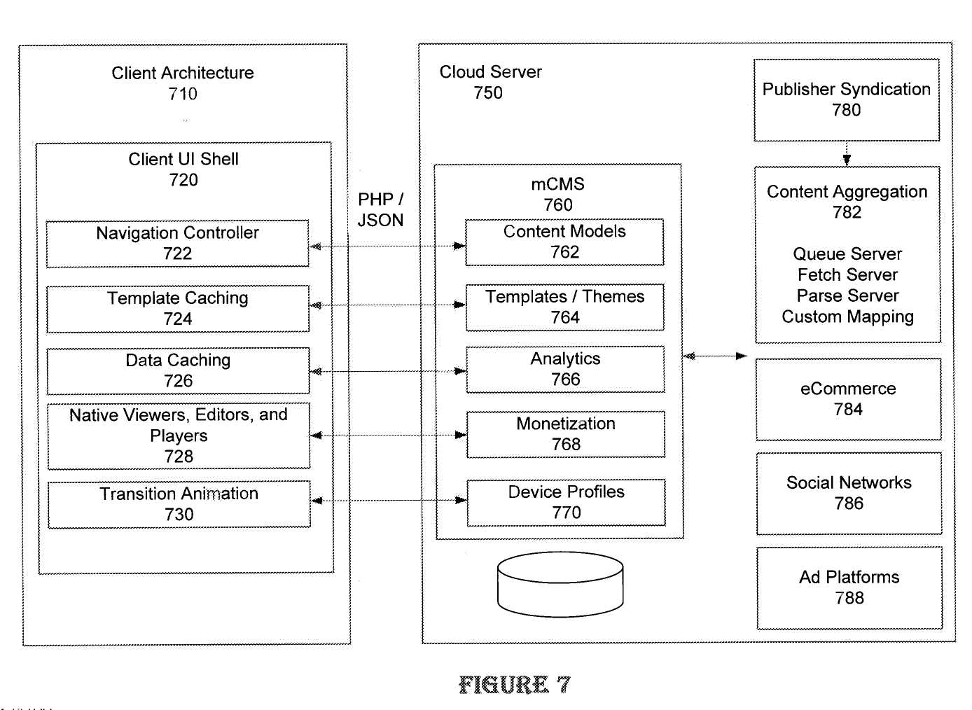

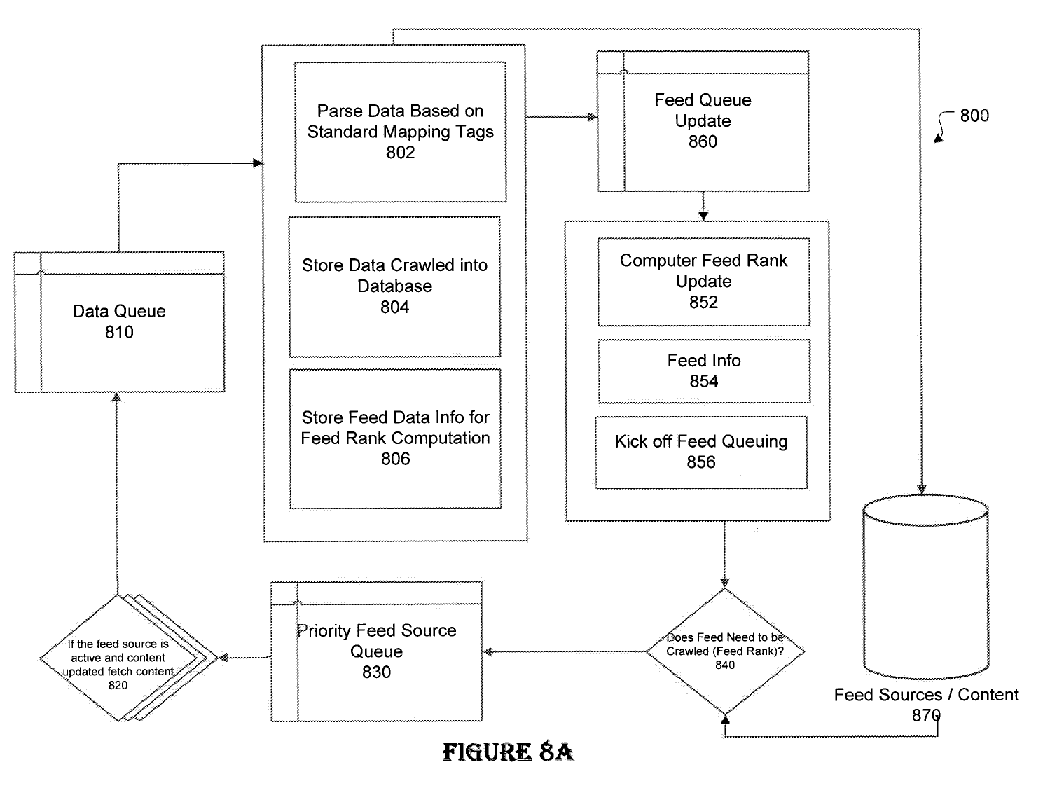

Turning now to FIG. 7, an overview of aspects of the system is illustrated. Client architecture 710 is available from a device. A client specific user interface shell 720 is provided as part of the flexible client architecture 710. From the client specific user interface shell 720, navigation controller 722, template caching 724, data caching 728, native viewers, editors and players 728 and transition animation 730 are all provided. The client architecture communicates with a cloud server 750, e.g., via PHP/JSON. The cloud server 750 includes the mobile content management system (mCMS) 760, which includes, for example, content models 762, templates and/or themes 764, analytics 766, monetization 768, and device profiles 770. A publisher syndication 780 is also positionable in communication with the cloud server 750. The publisher syndication 780 communicates with content aggregation 782, including, for example, a queue server, a fetch server, a parse server, and custom mapping. eCommerce 784, social networks 786, and ad platforms 788, are also provided.

Each of these features are in communication with the mobile content management system. The platform provides for data level aggregation, device specific content and media delivery, and facilitates branding management, structure and navigation. Additionally, usage, social sharing and location analytics are supported, along with monetization, distribution and app cross-promotion.

As will be appreciated by those skilled in the art, the cloud server 750 refers to the use of cloud computing which uses a logical computational resources (data, software) accessible via a computer network (through WAN or Internet etc. as described above with respect to FIGS. 1-2), rather than from a local computer resource.

The flexible client architecture provides as unique mechanism for content delivery and rendering within the mobile devices. Traditionally the data (Model) is bound to the layout (View) using software code (Controller) based on requests. This is a well-known software pattern called Model-View-Controller model. This method is usually implemented on the server while building web pages and the resulting page is delivered across the network to the browser. Flexible client architecture implements the MVC architecture in a unique way that makes it possible to create the content layouts within the app once with HTML and CSS and yet deliver it to various devices to be rendered.

By utilizing flexible client architecture the data is downloaded, for example, to the device in the form of JSON (Javascript Object Notation). The layout is downloaded in the form of HTML and CSS. The software code to bind the data and layout is in Javascript language and it is downloaded into the app too. The data is bound to the layout using Javascript on the fly within the app. As the binding is done at app runtime (data, view and code is downloaded) it can be changed dynamically and hence each time the page is constructed the app layout could be different. Such flexibility enables app publishers to create and manage highly complex apps in a very short time onto various platforms.

The content mapping and aggregation system also includes a layout engine which is part of the flexible client architecture. The flexible client architecture supports various mobile device form factors and offers a comprehensive solution for mobile publishing. By mapping the information prior to delivery, an app developer can provide continuous or near continuous new and updated content to end users without coding the information for optimization of delivery to a particular platform.

FIGS. 8A-B are a diagram of feed server and app support server. Feed queuer 840 analyzes feed sources based on feed rank and queues them into priority feeds source queue 830. Feed fetcher 820 fetches the raw data from feed sources and stores it in the data queue 810. Feeds parser reads the data from the data queue and parses the data based on standard mapping tags 802. Data extracted from such parsing mechanism is then stored in a database 804. The feed data info is stored 806 into the feed update queue 860. Feed queuer reads the feed update info 852, computes the feed rank and updates it in the feed info 854, and kicks of the feed queuing 856 cycle.

Content processor comprises of a token processor 892. Token processor identifies the app from the token and queries the database for app templates, and content based on app creator specified curation queries 890. The Token processor then returns the data (data, view, and code) back to the device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A mobile application development tool stored in a memory to generate an application comprising:
an application creation module adapted and configured to generate a mobile application for delivery to one or more mobile devices wherein each of the one or more mobile devices has a device platform and wherein the mobile application identifies one or more feed sources of information;
a content processor adapted and configured to format the one or more sources of information in a mobile device specific format prior to delivery to the one or more mobile devices;
a feed server adapted and configured to continuously or near continuously obtain, update and deliver content from the one or more feed sources to the mobile devices.

2. The mobile application development tool of claim 1 wherein the application creation module is adapted and configured to assess an application name for uniqueness.

3. The mobile application development tool of claim 1 wherein the application creation module is adapted and configured to assign a URL to the app.

4. The mobile application development tool of claim 1 wherein the application creation module is adapted and configured to generate an application in one or more languages.

5. The mobile application development tool of claim 1 wherein the application creation module is adapted and configured to at least one of accept an application description and accept one or more application tags.

6. The mobile application development tool of claim 1 wherein the feed sources are selected from the group comprising RSS, RDF, ATOM, and media RSS.

7. The mobile application development tool of claim 1 wherein the feed sources are services and further wherein the services are selected from the group comprising Twitter, Flickr, Blogger, Wordpress, Webshots and YouTube and any other social web services.

8. The mobile application development tool of claim 1 wherein the feed sources could be files in the format of text files, excel files, CSV, JSON, XML, Restful API, and Web-Services.

9. The mobile application development tool of claim 1 further comprising an application post component configurable to communicate a post having one or more of a title, content, image, link, and category.

10. The mobile application development tool of claim 1 further comprising an interface adapted and configured to display the mobile application in a plurality of mobile platform configurations.

11. The mobile application development tool of claim 1 further comprising an analytics module adapted and configured to provide one or more data elements selected from the group comprising number of apps downloaded, number of apps downloaded by platform, time, and language, number of application views, and number of apps viewed by platform, time, and language.

12. A method for mobile application development comprising:
creating a mobile application using an application creation module adapted and configured to generate a mobile application for delivery to one or more mobile devices wherein each of the one or more mobile devices has a device platform wherein the mobile application identifies one or more feed sources of information;
processing content for delivery via the mobile application with a content processor adapted and configured to format the one or more sources of information in a mobile device specific format prior to delivery to the one or more mobile devices;
configuring the mobile application for one or more mobile devices at an application server; and
publishing the mobile application via the Internet.

13. The method for mobile application development of claim 12 wherein the mobile application has a name and further comprising the step of assessing an application name for uniqueness.

14. The method for mobile application development of claim 12 wherein further comprising the step of assigning a URL to the app.

15. The method for mobile application development claim 12 wherein further comprising the step of generating an application in one or more languages.

16. The method for mobile application development of claim 12 further comprising at least one of accepting an application description and accepting one or more application tags.

17. The method for mobile application development of claim 12 further comprising the step of selecting the one or more sources from the group comprising RSS, RDF, ATOM, and media RSS.

18. The method for mobile application development of claim 12 wherein the sources are are services and further comprising the step of selecting the services from the group comprising Twitter, Flickr, Blogger, Wordpress, Webshots and YouTube.

19. The method for mobile application development of claim 12 further comprising providing a posting having one or more of a title, content, image, link, and category.

20. The method for mobile application development of claim 12 further comprising analyzing one or more application data elements selected from the group comprising number of apps downloaded, number of apps downloaded by platform, time, and language, number of application views, and number of apps viewed by platform, time, and language.

21. The method for mobile application development of claim 12 further comprising the step of generating a token and installing the token into the mobile application prior to delivering the application to an end user mobile device.

22. A method for maintaining a mobile application comprising:
processing content from one or more sources of information for delivery via a mobile application with a content processor adapted and configured to format the one or more sources of information for delivery to one or more mobile devices wherein each of the one or more mobile devices has a device platform;
configuring the content for the mobile device platform on a server without interaction with the mobile application receiving device; and
continuously or near continuously at least one of obtaining, updating and delivering content from the one or more feed sources to the mobile device based on device configuration information contained in a mobile device token.

23. The method for maintaining a mobile application of claim 22 further comprising providing a posting having one or more of a title, content, image, link, and category.

24. The method for maintaining a mobile application of claim 22 further comprising analyzing one or more application data elements selected from the group comprising number of apps downloaded, number of apps downloaded by platform, time, and language, number of application views, and number of apps viewed by platform, time, and language.

25. The method for maintaining a mobile application of claim 22 wherein the step of configuring the content further comprises the step of configuring the content from a plurality of sources in a plurality of formats for delivery to the mobile device.

26. A networked apparatus comprising:
a memory;
a processor;
a communicator;
a display; and
an application creation module adapted and configured to generate a mobile application for delivery to one or more mobile devices wherein each of the one or more mobile devices has a device platform wherein the mobile application identifies one or more feed sources of information, a content processor adapted and configured to format the one or more sources of information in a mobile device specific format prior to delivery to the one or more mobile devices, a feed server adapted and configured to continuously or near continuously obtain, update and deliver content from the one or more feed sources.

27. A mobile application maintenance tool stored in a memory to maintain an application comprising:
an application maintenance module adapted and configured to update a mobile application for delivery to one or more mobile devices wherein each of the one or more mobile devices has a device platform wherein the mobile application identifies one or more feed sources of information;
a content processor adapted and configured to format the one or more sources of information in a mobile device specific format prior to delivery to the one or more mobile devices; and
a feed server adapted and configured to continuously or near continuously obtain, update and deliver content from the one or more feed sources.

28. Non-transitory, computer-readable storage media for tangibly storing thereon computer readable instructions for a method comprising:
receiving a request from a mobile device;
a mobile application communicating the request to a server causing the server to identify a mobile device type;
in response to identifying the mobile device type, delivering information to the mobile device in a format suitable for display on a mobile device interface.

29. A mobile application mapping system stored in a memory comprising:
a dynamically configurable content mapping system adapted and configured to format one or more sources of content for delivery to one or more mobile devices wherein each of the one or more mobile devices has a device platform in a format adapted and configured for display on each of the mobile device platforms prior to delivery to the one or more mobile devices; and
a feed server adapted and configured to continuously or near continuously obtain, update and deliver content from the one or more sources of content to the one or more mobile devices.

30. The mobile application mapping system of claim 29 wherein the one or more sources of content are selected from the group comprising RSS, RDF, ATOM, and media RSS.

31. The mobile application mapping system of claim 29 wherein the one or more sources of content are services and further wherein the services are selected from the group comprising Twitter, Flickr, Blogger, Wordpress, Webshots and YouTube and any other social web services.

32. The mobile application mapping system of claim 29 wherein the dynamically configurable content mapping system is adapted and configured to apply one or more tags to the one or more sources of content.

33. The mobile application mapping system of claim 32 wherein the feed server is further adapted and configured to aggregate data from the one or more sources of content based on the one or more tags applied to the one or more sources of content.

34. An interface module stored in a memory comprising:
a content mapping system adapted and configured to format one or more sources of content for delivery using standard compliant scripting language to one or more mobile devices having one or more mobile device platforms in a format adapted and configured for display on each of the mobile device platforms prior to delivery to the one or more mobile devices; and
a feed server adapted and configured to obtain, update and deliver content from the one or more sources of content to the one or more mobile devices.

35. The interface module of claim 34 wherein the one or more sources of content are selected from the group comprising RSS, RDF, ATOM, and media RSS.

36. The interface module of claim 34 wherein the one or more sources of content are services and further wherein the services are selected from the group comprising Twitter, Flickr, Blogger, Wordpress, Webshots and YouTube and any other social web services.

37. The interface module of claim 34 wherein the content mapping system is adapted and configured apply one or more tags to the one or more sources of content.

38. The interface module of claim 37 wherein the feed server is further adapted and configured to aggregate data from the one or more sources of content based on the one or more tags applied to the one or more sources of content.

39. The interface module of claim 34 wherein the standards compliant scripting language is one or more of HTML, CSS and Java Scipt.

40. The interface module of claim 34 further comprising a content curator adapted and configured to curate content from a plurality of content sources having one or more content formats into a unified format for delivery to the mobile devices.

41. A system comprising:
a flexible client architecture comprising a client interface shell, a navigation controller, a template caching apparatus, a data caching apparatus, one or more of a native viewer, an editor, a player, and a transition animator stored on a memory;
a mobile content management system adapted and configured to provide one or more of content models, templates, analytics, monetization, and device profiles stored on a memory;
a publisher syndicator stored on a memory;
a content aggregator including one or more of a queue server, a fetch server, and a parse server,
wherein the flexible client architecture is adapted and configured to be in communication with the mobile content management system via a cloud server.

42. The system of claim 41 further comprising a mobile application mapping system stored in a memory comprising a dynamically configurable content mapping system adapted and configured to format one or more sources of content for delivery to one or more mobile devices having one or more mobile device platforms in a format adapted and configured for display on each of the mobile device platforms prior to delivery to the one or more mobile devices; a feed server adapted and configured to continuously or near continuously obtain, update and deliver content from the one or more sources of content to the one or more mobile devices.

43. The system of claim 41 wherein the one or more sources of content are selected from the group comprising RSS, RDF, ATOM, and media RSS.

44. The system of claim 42 wherein the one or more sources of content are services and further wherein the services are selected from the group comprising Twitter, Flickr, Blogger, Wordpress, Webshots and YouTube and any other social web services.

45. The system of claim 41 wherein the dynamically configurable content mapping system adapted and configured apply one or more tags to the one or more sources of content.

46. The system of claim 45 wherein the feed server is further adapted and configured to aggregate data from the one or more sources of content based on the one or more tags applied to the one or more sources of content.
